(19) United States
(12) Patent Application Publication
(10) Pub. No.: US 2006/0286528 A1
(43) Pub. Date: Dec. 21, 2006

(54) Interactive multimedia reading method, products and methods of conducting business

(76) Inventor: Clifford E. Harshman, Vashon Island, WA (US)

Correspondence Address: John P. Luther;Newman & Newman LLP, 505 Fifth Avenue South, Seattle, WA, 98104, US

(21) Appl. No.: 11/146,617

(22) Filed: Jun. 6, 2005

(51) Int. Cl. G09B 5/00

(52) U.S. Cl. 434/317

(57) ABSTRACT

The present invention provides an interactive multimedia learning and comprehension reading method and product which combines conventional reading of printed and written materials with movies or movie segments or video or video segments on demand, and which are synchronized with related textual, graphical or pictorial portions of written and/or printed material.

### COPYRIGHT NOTICE

Copyright 2005 Clifford E. Harshman. All rights reserved. A portion of the disclosure of this patent application/patent document contains material which is subject to copyright protection. The copyright owner has no objection to facsimile reproduction by anyone of the patent document or the patent disclosure as it appears in the United States Patent and Trademark Office file or records.

### FIELD OF THE INVENTION

The present invention relates to an interactive reading method and/or cognitive reading method, system and products in which written and/or printed text materials, images, graphics and the like are augmented with video and movie segments and other audio and/or pictorial narrations.

### BACKGROUND OF THE INVENTION

Applications for use with personal computers have multiplied in recent years, especially with many new advances in the publishing field, such as in the multimedia publishing arena. Many new software applications are available which offer a combination of text, images, and audio enabling an array of multimedia presentations. The proliferation of CD-ROM and DVD drives available with personal computer and laptop units has been seen to accelerate these developments.

Some have found such developments disconcerting, and as never being able to replace the age old enjoyment of traditional book reading. Others, however, have found the option of media augmentation, such as sound and imagery, to be welcome additions for the enhancement of reading comprehension, understanding, and overall enjoyment, especially in a cognitive reinforced learning sense.

Some recent examples include that disclosed in U.S. Pat. No. 5,957,697. In this method a printed text is augmented with password accessible electronically stored data in the form of images, sounds, and/or supplemental text, or data. Supplemental data may be maps or photographs, illustrations of characters referred to in the text, sound narrations of the text, sound effects associated with events portrayed in the text, sidebars relating to the text, and alternative and unabridged accounts of events portrayed in the text, such as a “running synopsis”. Any of such items can be accessed by entering a page number of the printed text following an appropriate prompt from a user interface. Additionally, such items are stored in a remote database with access thereto through the Internet or may be locally available in a user's computer in the form of a CD-ROM, floppy disk, hard disk or other data storage medium. In other applications, this method discusses a graphical user interface for a reader to link or access information related to the textual content of the book, such as text vocalization.

In U.S. Patent Application No. 6,269,238, there is also discussed a printed book which is augmented with associated electronic data. In this method, a printed book is provided with indicia in portions of the text which is associated with electronically stored data, such as stored in a remotely accessible server. When the reader of the book desires to access data association with a portion of the text, the reader uses a computer pointing device to select or manipulate indicia on a graphical user interface corresponding to a visual cue in the book. The server next retrieves the appropriate data which is then presented to the reader as images, sounds and/or “supplemental text” on the reader's computer to provide a multimedia enhanced reading experience. U.S. Pat. No. 6,549,250 discloses a similar electronic data augmented book method in which electronically stored data is in the form of a glossary of words.

Other more recent examples include that disclosed in U.S. Published Patent Application No. 20040175095, which provides a media article comprising a media member for play by a user which includes text material, an audio narrative of the text material synchronized with the text material as it is presented to the user and a plurality of successively presented images with which the text material is combined in sequence. The visual images are related to the text, such as illustrations of a described scene, such that the resulting media article comprises a succession of visual images with the text thereon and an audio component narrating the text as it appears. This method is basically an extension of the well known audio books or books on tape in which the actual text of a book is read by an experienced and skilled reader, and perhaps with a distinctive or recognized voice. Such audio book includes an array of well known commercially available reading materials. There being no illustrations, however, such are supplied along with sound by this system.

A further example is disclosed in European Patent Application No. 1308956 which provides a method and apparatus for reproducing content from an information storage-medium, such as a DVD disc, in an interactive mode. This method includes receiving or reading information necessary for reproducing the content in the interactive mode, such as from the Internet or a storage medium, and then reproducing the content in a interactive mode based on a combination of received or read information.

In a similar example, in Japanese Patent Abstract No. 2002245195 there is disclosed a combination entertainment system comprising combining subject matter from a book, a DVD and a portable telephone set. In use, the method employs a locked and non-enjoyable program, and another enjoyable program accessible by a keyword and book including a telephone set, wherein the locked and non-enjoyable program in the DVD can be unlocked and enjoyed by imputing the keyword.

Further, in U.S. Published Patent Application No. 20040054826, there is disclosed a portable handheld device for enabling interactivity of video content. In this method and product, there is provided a game control unit which includes a computer processor for executing game logic stored on a removable memory device. Audiovisual content for the interactive gaming experiences is provided on a DVD in small clips which can be selectively played back in a standard DVD player under control of the game control unit. The game control unit mimics standard remote control signals to control playback of the audiovisual content by the DVD player.

An enhanced reading multimedia system and method is disclosed in U.S. Published Patent Application No. 20030059758 which integrates a printed book, and associated interactive electronic data stored on a remote database. The printed book contains indicia to identify the location of the interactive electronic and visual cues which are disposed throughout the printed book to indicate the availability of electronic data associated with printed material located in the proximity of the visual cue. A reader of the printed book will employ the indicia and the visual cues to access the interactive electronic data with individual portions of the interactive electronic data corresponding to portions of the printed book, said to create an engaging reading experience. As in other conventional methods, the individual portions of the interactive data include supplemental text, images, sounds, multimedia and/or multimedia animation which relate to portions of the book. In operation, the printed book contains an emblem which indicates the location of the interactive electronic data and the visual cues dispersed throughout the book which corresponds to specific portions of the interactive electronic data. The specific portions are said to relate to the printed material in the proximity of the visual cues. By way of a computer, a reader employs the emblem and the visual cue to access the individual portions of the interactive electronic data with an interface provided for reader interaction with the individual portions of the interactive electronic data. After interacting, the reader can return to reading the printed book. The reader interaction with the electronic data is also said to result in such data providing a return point which is a function of the interaction. The return point instructs the reader to resume reading the printed book at a specific point within the book. In a preferred embodiment, a reader of a printed book may access electronic data via the Internet using a browser running on a computer. The book may be an ordinary book containing a plurality of pages, or an electronic book electronically displayed on a computing device, such as a mainframe computer, personal computer, personal digital assistant (“PDA”) or other device capable of displaying text and/or graphics.

As one may discern from this sampling of conventional techniques, there exists much interest in this area, and also much room for improved techniques of learning and comprehension, especially in a cognitive sense.

### SUMMARY OF THE INVENTION

In accordance with the present invention, there is provided an interactive multimedia learning and comprehension reading method and product which combines conventional reading of printed and written materials with movies or movie segments or video or video segments on demand, and which are synchronized with related textual, graphical or pictorial portions of written and/or printed material.

The invention is more explained and understood with reference to the following Detailed Discussion of Preferred Embodiments and accompanying drawings.

### BRIEF DISCUSSION OF THE DRAWINGS

FIG. 1 illustrates a diagrammatic view of an embodiment of the inventive cognitive reading method and system of the invention.

FIG. 2 illustrates an additional diagrammatic view of an embodiment of the reading method and system of the invention.

### DETAILED DISCUSSION OF PREFERRED EMBODIMENTS

All patent reference published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

In the following discussion, many specific details are provided to set forth a thorough understanding of the present invention. It will be obvious, however, to those skilled in the art that the present invention may be practiced without specific details, and in some instances of this discussion with reference to the drawings known elements have not been illustrated in order not to obscure the present invention in unnecessary detail. Such details concerning computer networking, software programming, telecommunications, and the like have not been specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some preferred embodiments, the functions are performed by a processor such as a computer or an electronic data processor in accordance with code, such as a computer program code, software, and/or integrated circuits that are coded to perform such functions.

Additionally, the processing that is depicted in the drawings and described below is generally depicted as hierarchical structure for readability and understandability. Various other methodologies, such as object oriented techniques, are preferred for the physical embodiments of the invention in order to maximize the use of existing programming technique. One of ordinary skill in the art will appreciate that the techniques described herein may be embodied in many different forms.

For illustrative purposes only, the following discussion illustrates and discusses the present invention in reference to various embodiments which may perhaps be best utilized subject to the desires and subjective preferences of various users. One of ordinary skill in the art will, however, appreciate that the present invention may be utilized to enhance the reference capacities, cognitive learning skills, and enhanced learning and appreciation in general.

Having thus prefaced this discussion, one major advantage of the present invention, of which there are several, is the enhanced learning and comprehension ability it affords through its similarity to a cognitive learning approach, as opposed to a much less efficient and problem prone approach of rote memorization procedures or of redundant reading in attempting to digest complex or difficult subject matter. An enhanced learning or understanding ability with respect to certain printed or written material unquestionably makes for a heightened enjoyment of reading such material in any event.

Cognition refers to mental activity which includes thinking, remembering, learning, and using language, among other things. It has also been described as an active recursive, integrated process in which information is modified to reconstruct what one knows. As opposed to rote memorization or perhaps multiple re-readings, a cognitive approach to learning and teaching, or otherwise understanding the content of a textual document and/or image, focuses on the understanding of information and concepts. The ability to understand the connection between concepts and to process information by rebuilding it with logical connections, such as summarizing in one's own words, or listening to or reading summaries by others, or more preferably being able to watch a movie or video depicting (or substantially depicting) the storyline of text or contents of any written or printed material is known to increase one's retention and understanding, and in many instances the enjoyment of written and printed subject matter such as a book one has been desirous of reading. As one may readily understand, such an approach is not only useful in the relaxed and informal reading of novels, non-fiction, historical works and the like, but also finds important use in the classroom and other applications throughout society, such as in the digestion and understanding of transactional and scientific documents, operational manuals, training manuals, voluminous business and financial reports, company business summaries and yearly reports, SEC filings, depositions, briefs and other legal-related documents to name only a few.

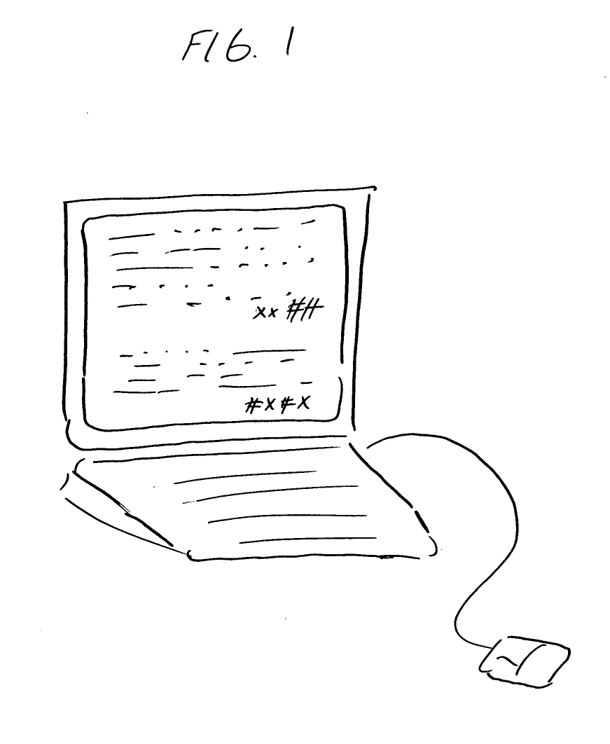

In one aspect, the present invention employs a cognitive approach to learning, understanding and digesting the content or subject matter of written and printed material, such as text in the form of a book. In this aspect, in accordance with the present invention, there is provided an interactive multimedia learning and comprehension reading method and product which combines conventional reading of printed and written materials with movies or movie portions or segments, or video or video segments or with streaming video, preferably with characters portrayed by human beings, which are synchronized with text or other written or printed subject matter currently being read or for reading by the user. Referring now to FIG. 1, there is depicted in this illustration readable text, which includes code, or other indicia placed for example, at the end of each paragraph, or page, which is interfaced, or otherwise refers to a synchronized portion of a movie or movie clip, or video or video portions, which portrays the subject matter of that portion of readable text, such as a point in the storyline of a fictional novel, an historically-based novel, a historical text or other printed or written textual material. Without limitation, readable textual material, whether written on printed, or in electronically reproduced form may be, for example, a book with a plurality of pages, a financial report or company filing, such as an SEC report or yearly report, a scientific publication, such as a scientific journal or something on the order of Scientific American, instructional use manuals, operational manuals, personal narratives, manuscripts for plays and movies, legal briefs, pleadings and depositions, pictures, charts, such as for use with navigation, maps, graphs or other types of printed material, many of which may not be easily comprehensible or easy to digest or absorbed, at least on first reading, or which do not lend themselves easily to rote memorization and understanding. Many books have been made into classical movies, and all of which are appropriate subject matter for the present invention. Some noteworthy examples include, for instance, The African Queen, Apocalypse Now, Amadeus, Alice in Wonderland, The Adventures of Huckleberry Finn, A Space Odyssey, Bonfire of the Vanities, Cape Fear, Catch-22, Carrie, Born on the Fourth of July, The Big Sleep, Dr. Zhivago, Dracula, Clockwork Orange, Clear and Present Danger, Die Hard, All the Presidents Men, The Accidental Tourist, Bridges of Madison County, Blade Runner, The Godfather, Get Shorty, Frankenstein, Forrest Gump, Field of Dreams, and The Last of the Mohicans to name only a few. Some educational publishers specialize in movies based on books, such as Space Case which is based on the book by Edward Marshall and My Louisiana Sky which is based on the novel by Kimberly Willis. Some books have been made into movies a number of times with several variations or interpretations available. As an example, there are 1973 and 1995 versions of From the Mixed up Files of Mrs. Basil E. Frakweiler. Films or movies have also been based on well-known comic strips, fairy tales and short stories, with some noteworthy examples being Batman, X-Men, and Spiderman. Stephen King is well-known for turning out films based on short stories, such as Stand By Me. Many books have also been made into television series.

While book-movie combinations have been on the market for some time, one must still read the book and watch the movie separately. Conceivably, one may keep a copy of a book in hand while trying to watch the movie or film clip on which it is based, but such an endeavor is nothing but awkward, as we all know, as many movies or films based on books do not coincide well with the written material.

In accordance with the present invention, in some preferred embodiments one may purchase a book or other written or printed textual, graphical or pictorial material, or various combinations thereof, which is accompanied by a CD, DVD or other electronically digitized, or otherwise reproduced, movie, film, film clip, video or streaming video and the like in which human beings as actors preferably portray or act out a version or interpretation of the written or printed subject matter, and in which one reading the printed or written material, or otherwise observing the material, may actuate a code or icon and the like and immediately cross-reference and view the applicable portion of movie, film clip or video portion which relates to the portion of subject matter being read or observed.

Any of the commercially available movies based on books, such as exemplified above, may be used herein, or one or more actors engaged to manufacture a movie, video or film, or segments thereof, as based on a book or any written or printed material for that matter, for use in the present invention. One may ascertain the absence of potential copyright problems in following the later course of production, and find this route preferable.

In some embodiments, a video or movie based on a novel or any textual, written or printed material may be manufactured by well-known video/film equipment and methods. Other examples are fabricated as a matter of course, such as video depositions and the like. Videos may be composed of an actor, or anyone, describing and/or otherwise portraying, or acting out an interpretation of the facts and events and other material described in such written and printed matter as, without limitation, business reports, company meetings, scientific journals, operating manuals, repair manuals, or legal and other scholarly texts. An adaptation and movie or video interpretation may conceivably be manufactured as based on virtually any written a printed material, and any of which may be employed in accordance with the present invention. While audio versions may be understandably preferable to some, such are not critical to the practice of the invention. In many instances silent movies may be preferable for use in conjunction with readable or observable printed or written material in accordance with the invention, such as for use in libraries or use by the impaired. Movies or videos may be shown on a video screen or monitor, or other display device such as that of a camera phone capable of receiving multimedia messages, and be synchronized with readable or observable printed or written material such that each portion thereof may be correlated and immediately cross-reference to the applicable portion in the movie or video.

In the production of movies or videos, or segments thereof, in accordance with the invention, such may be broken down into separate panels, or cells such as in animation, and each panel or groupings of panels coded or otherwise indicated with indicia for match up, i.e. illustrate or correspond to, the particular words, scene, events or subject matter in printed or written material which may be cross-referenced at will by accessing or actuating such codes or indicia, such as by point and click techniques by way of a browser. Bar coding is an example of one preferred form of cross-referencing indicia for printed material/written material segment-movie segment match up for viewing or observing. The indicia may be located any place throughout the written or printed material, such at the end of each paragraph or page, or particular groupings of words, and matching indicia may be liberally dispersed throughout a movie or video for access thereto on a video screen and the like any portion thereof as desired while reading corresponding portions of the written or printed material. The merger of printed/written material with matching or corresponding video or movie portions may be carried out by commercially available software, such as used in producing animations corresponding to books and the like, and coded movies or videos placed in known content form which can be transferred conveniently to a DVD disk. The DVD and/or the audio CD may be commercially reproduced for distribution as an interactive media product in accordance with the invention.

In further embodiments the interactive media product may be accessed through the Internet by way of a web site, such as a pay site for access to the products of the invention. In this mode a user reading or reviewing printed or written material which has been coded or provided with appropriate indicia may access a web site, for instance, by way of a password, and gain access to a corresponding movie or video.

The interactive media products may also be available through wireless phone devises which are Multimedia Message Service (“MMS”) enabled. Multimedia messaging is a progeny of the Short Message Service (“SMS”) text messaging, and is the latest approach for transmitting messages and other media between different mobile users and/or between mobile users and the Internet via an e-mail address. MMS multimedia messages may include in addition to text, sound, images, graphics, animations, and most importantly for application to the present invention video and video clips which may be accessed by code at will. Formats that may be embed with MMS messaging may include text format with fonts, colors and the like, images (DPEG, GLF format and animation GLF), audio (MP3, VTLV, AMR, MIPI) and video (MPEG and Real Media) and various combinations thereof, with images being downloaded, for example, into an individual's mobile phone devise from a WAP site, such as selected from a menu within the phone. MMS is a store and forwarding messaging service which allows mobile subscribers the ability to exchange multimedia messages with other mobile subscribers, or the ability to send multimedia content in a single message and to send the multimedia message to multiple recipients, which presents an ideal platform for distribution of the interactive multimedia products of the invention for use in conjunction with appropriate printed or written materials.

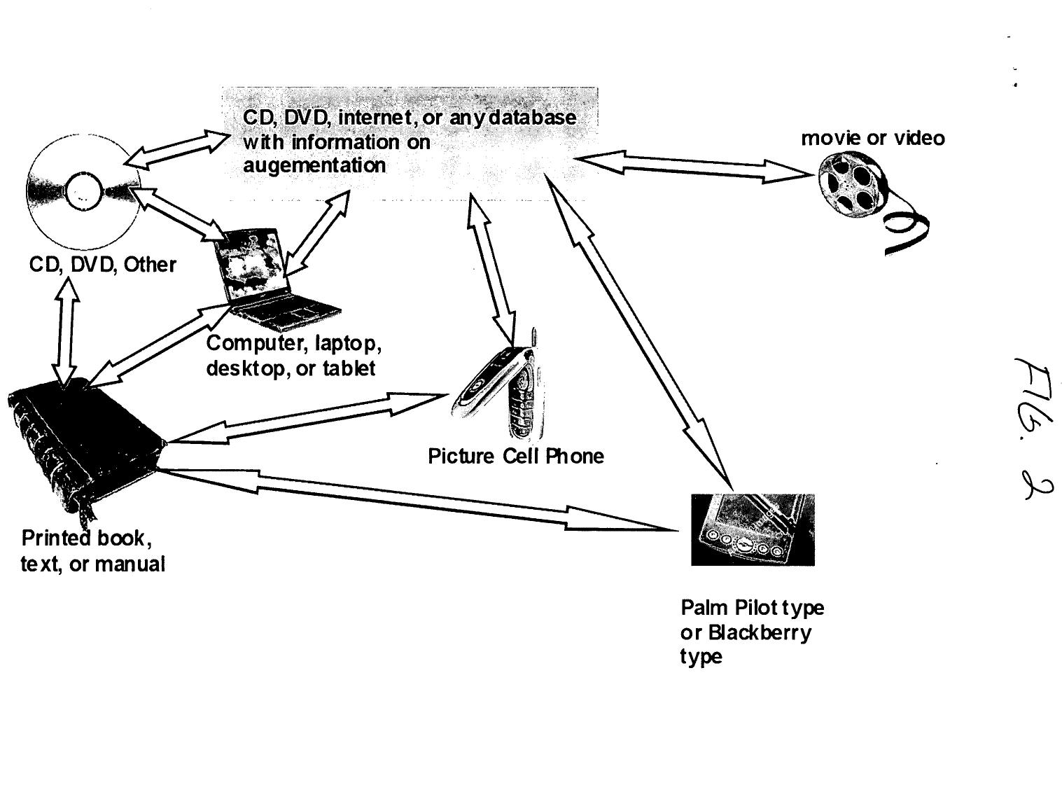

As shown, for example, in FIG. 2 the inventive method and system may be accessed and/or practiced through a variety of venues. For instance, printed readable material with access codes to movie clips of portions thereof may be provided on a CD or DVD as usable in a PC or laptop unit, or, as illustrated, a CD or DVD containing readable material may be inserted in to a station such as a laptop, a website accessed, and, perhaps through a password or code, access by way of the website to coded movie or video segments corresponding to readable portions on the material on the CD or DVD enabled as desired by the user. In other instances, a user may access the readable material with corresponding movie or video portions entirely through a website, such as password access and the like. In still other embodiments, for instance, a user may access by MMS messaging printed written material on a wireless device, such as cell phone with MMS capability, or other such enabled deviceTthrough coded entry the user may pull up corresponding and synchronized movie and/or video clips on demand on the device as desired, and then return to the written readable material. In use, any conventional or non-conventional phone device or the equivalent thereof is contemplated for use in this invention, including cell phones from any catalog of the many mobile phone device vendors, some of which have the capability and appearance of a personal computer, or which are generally multifunctional. The present inventive method and system is also contemplated for use with any wireless or mobile combination network. Mobile phone devices for use with this invention may also be Internet enabled to download products and services, for example, purchased from a service provider.

As will be further appreciated by those persons skilled in the art, the present inventive method and system, inclusive of one or more embodiments of its operation through various software and hardware systems, affords distinct business advantages not previously available to vendors relating to the sale and the distribution of printed materials such as books, textbooks and other forms of such material as described above. In this aspect, the present invention provides novel methods of conducting an array of business functions including, without limitation, inter alia, designing, manufacturing, using, marketing, selling, licensing and/or leasing the inventive subject matter, or of developing business goodwill, of developing valuable trademark rights in conjunction with the use thereof, and further in providing subject matter for novel methods of business entity formation, such as partnerships, corporations, joint ventures and other collaborations for the purpose of exploiting the business of the inventive subject matter.

While this invention has been described in connection with what is presently considered to be the most practical and preferred embodiments, it is to be understood that the invention is not to be limited to disclosed embodiments in any way as such are merely set forth for illustrative purposes. The present inventive method and system, and methods for conducting business in general, are intended to cover a wide array of various modifications and equivalent arrangements, all of which are contemplated for inclusion within the scope and spirit of the disclosure and appended claims.

1. An interactive multimedia product comprising a movie means or video means, or segments thereof, for viewing by a user having one or more portions thereof which correspond to, or synchronize to, portions of readable and/or observable printed or written material, and wherein said synchronized movie means or video means portions are effective to be accessed on demand by a user reading or observing said printed or written material.

2. The product of claim 1 wherein said movie means and/or video means is in the form of a DVD or CD.

3. The product of claim 1 wherein said movie means and/or video means is accessible through a network means.

4. The product of claim 1 wherein said movie means and/or video means is accessible through multimedia messaging by way of a wireless phone device.

5. The product of claim 1, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

6. (canceled)

7. (canceled)

8. (canceled)

9. (canceled)

10. (canceled)

11. (canceled)

12. (canceled)

13. (canceled)

14. (canceled)

15. (canceled)

16. An interactive multimedia product comprising a movie means or video means, or segments thereof, for viewing by a user, having one or more portions thereof which correspond to, or synchronize to, portions of readable and/or observable printed or written material, wherein said synchronized movie means or video means portions are effective to be accessed on demand by a user reading or observing said printed or written material, and further wherein said movie means or video means comprises a human being acting out interpretations of said printed or written material.

17. The product of claim 16 wherein said movie means and/or video means is in the form of a DVD or CD.

18. The product of claim 16 wherein said movie means and/or video means is accessible through a network means.

19. The product of claim 16 wherein said movie means and/or video means is accessible through multimedia messaging by way of a wireless phone device.

20. The product of claim 16, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

21. (canceled)

22. (canceled)

23. (canceled)

24. (canceled)

25. (canceled)

26. (canceled)

27. (canceled)

28. (canceled)

29. (canceled)

30. (canceled)

31. The product of claim 2, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

32. The product of claim 3, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

33. The product of claim 4, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

34. The product of claim 17, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

35. The product of claim 18, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.

36. The product of claim 19, wherein said printed or written material is selected from a conventional book with a plurality of pages, financial reports, business reports, a regulatory filing, a scientific publication, an instructional use manual, an operational manual, a personal narrative, a manuscript for a play, a manuscript for a movie, a manuscript for a book, a brief, a pleading, a deposition, pictures, charts, maps, graphs, military specifications, educational materials, medical industry materials, statistical compilations, manufacturing manuals, contracts and agreements, and warranties and any combination thereof.
